(19) United States
(12) Patent Application Publication
(10) Pub. No.: US 2008/0220392 A1
(43) Pub. Date: Sep. 11, 2008

(54) PROPHY ANGLE ADAPTER WITH MULTIPLE COUPLINGS AND COLLET FOR RECEIVING ROTATING MEMBER

(76) Inventors: Chris J. Carron, Bloomsdale, MO (US); David G. Grither, Ste. Genevieve, MO (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(21) Appl. No.: 11/682,927

(22) Filed: Mar. 7, 2007

(51) Int. Cl. A61C 3/06

(52) U.S. Cl. 433/125

(57) ABSTRACT

An adapter for a prophy angle includes a collet, a nose, a body, and a shaft. The collet is configured to connect to a rotating member of the prophy angle. The nose has a first bore and is configured to receive the rotating member through the first bore. The body has a second bore and is connected to the nose. The shaft is positioned within the second bore of the body, and the shaft include a first distal end and a second distal end. The first distal end connects to the collet, and the second distal end includes a coupler. The collet includes a plurality of extensions for attaching to the rotating member. A fixed-diameter collet bore is defined by innermost portions of the extensions, and the collet bore has a diameter smaller than a diameter of the rotating member.

### BACKGROUND OF THE INVENTION

1. Field of the Invention

The disclosure relates generally to dental instruments and, more specifically, to adapters for use with prophy angles.

2. Description of the Related Art

Dental prophylaxis angles, generally referred to as “prophy angles,” are commonly used dental instruments for providing rotation for dental tools such as brushes, prophy cups, or other receptacles used in cleaning/polishing teeth. Referring to FIGS. 12 and 13, a prophy angle 10 typically includes a housing 16 having a neck 18 and a head portion 14 extending at approximately a 90° angle to the neck 18, which increases the ability of a dentist to reach various surfaces of the teeth of a patient. A drive shaft or rotating member 12 can be located within the housing 16 and attached to a driven gear 20 in the head of the prophy angle. Prophy angles 10 are generally affixed to an adapter or hand piece (not shown), which connects the prophy angle to a drive source (not shown), thereby enabling a rotating motion of the rotating member 12 and driven gear 20 of the prophy angle and any affixed dental tool.

Prophy angles 10 are commonly manufactured from lightweight plastic to make them disposable, thereby increasing overall sterility in the dental environment. An issue associated with making the prophy angles 10, and their constituent elements, such as the rotating member 12, from plastic is the ability of the hand piece to engage the rotating member 12 without slipping and to engage the rotating member 12 without excessive damage to the rotating member 12. Another issue associated with the use of prophy angles 10 is the widespread use of many different and incompatible types of couplings between the drive source and the hand piece and between the hand piece and the prophy angle 10.

There is, therefore, also a need for an adapter that provides a robust coupling between the adapter and the prophy angle. A need also exists for an adapter that is capable of combining prophy angles and drive sources having different types of couplings.

### BRIEF SUMMARY OF THE INVENTION

Embodiments of the invention address deficiencies of the art with respect to a creating a robust coupling between the adapter and the prophy angle and to combine prophy angles and drive sources having different types of couplings. In this regard, an adapter for a prophy angle includes a collet, a nose, a body, and a shaft. The collet is configured to connect to a rotating member of the prophy angle. The nose has a first bore and is configured to receive the rotating member through the first bore. The body has a second bore and is connected to the nose. The shaft is positioned within the second bore of the body, and the shaft include a first distal end and a second distal end. The first distal end connects to the collet, and the second distal end includes a coupler. The collet includes a plurality of extensions for attaching to the rotating member. A fixed-diameter collet bore is defined by innermost portions of the extensions, and the collet bore has a diameter smaller than a diameter of the rotating member.

In certain aspects of the adaptor, the first bore and the second bore extend along a common axis. Alternatively, the first bore and the second bore extend along separate axes. Also, the first distal end of the shaft may connect to the collet with a rotation joint, such as a ball joint. The nose is a doriot-style nose, and the coupler is an E-type coupler.

In further aspects of the adaptor, the outer portions of the extensions include concave surfaces. Also, a radius of the concave surfaces of the extensions is substantially equal to the radius of the collet bore. Additionally, the extensions include longitudinal chamfers sloping inwardly towards a rotational axis of the collet.

In yet other aspects of the adaptor, the shaft has a rotational axis and the collet has a rotational axis. In operation of the adaptor, the nose is rotatable relative to the body about an axis perpendicular to either the rotational axis of the shaft or the rotational axis of the collet. In so doing, an angle between the rotational axis of the shaft and the rotational axis of the collet is variable.

According to another embodiment, a prophy angle driver includes a collet, a nose, a micromotor, and a shaft. The collet is configured to connect to a rotating member of a prophy angle. The nose has a first bore and is configured to receive the rotating member through the first bore. The micromotor is attached to the nose. The shaft extends from the micromotor into the first bore and is connected to the collet. The collet includes a plurality of extensions for attaching to the rotating member. A fixed-diameter collet bore is defined by innermost portions of the extensions, and the collet bore has a diameter smaller than a diameter of the rotating member.

According to yet another embodiment, a contra-angle prophy angle driver includes a collet, a nose, and a shaft. The collet is configured to connect to a rotating member of a prophy angle. The nose has a first bore and is configured to receive the rotating member through the first bore. The micromotor is attached to the nose. The shaft extends from the micromotor into the first bore and is connected to the collet by a ball joint.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A and 1B are, respectively, a side view and side cross-sectional view of a straight adapter in accordance with the inventive arrangements;

FIG. 2 is a side, cross-sectional, exploded view of the straight adapter;

FIGS. 3A-3C are, respectively, a front perspective view, a front plan view, and a side cross-sectional view of a collet in accordance with the inventive arrangements;

FIGS. 4A and 4B are, respectively, a side view and side cross-sectional view of a contra-style adapter in accordance with the inventive arrangements;

FIGS. 5A-5C is a side, exploded view of the contra-style adapter;

FIGS. 6A-6D are, respectively, a perspective view of a receiver, a perspective view of the receiver and a second pin, a perspective view of a first pin and the second pin, and a perspective view of the first pin and the second pin position within a head of a ball joint in accordance with the inventive arrangements;

FIGS. 7A and 7B are, respectively, side and top views of the head of the ball joint and a shaft to which the head is connected;

FIGS. 8A and 8B are, respectively, a side view of the collet and shaft with one embodiment of a joint between the collet and shaft in accordance with the inventive arrangements and a side cross-sectional view of the collet, shaft, and joint within the adapter;

FIG. 9 is a side view of the collet and shaft with another embodiment of a joint between the collet and shaft in accordance with the inventive arrangements;

FIG. 10 is a side cross sectional view of the collet and shaft within the adapter with another yet embodiment of a joint between the collet and shaft in accordance with the inventive arrangements;

FIGS. 11A and 1B are, respectively, side and side cross-sectional views of an adapter with an integral micromotor;

FIG. 12 is a perspective view of a prophy angle according to the prior art; and

FIG. 13 is a side cross-sectional view of the prophy angle according to the prior art.

### DETAILED DESCRIPTION OF THE INVENTION

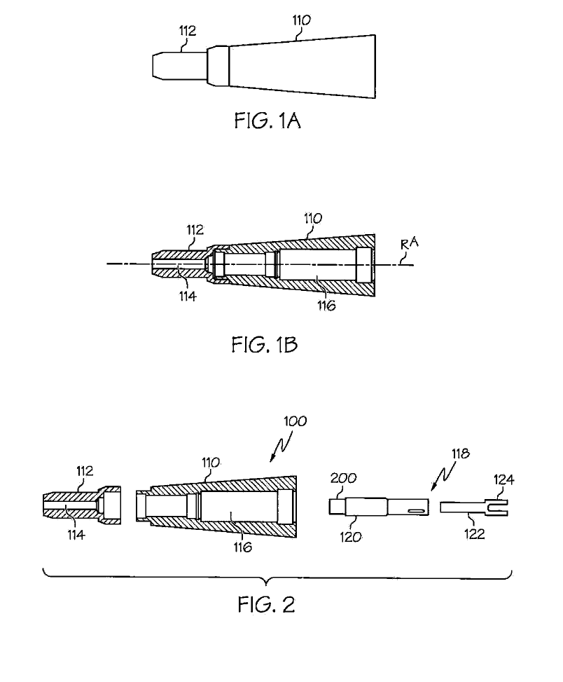

FIGS. 1A, 1B and 2 illustrate an exemplar straight adaptor 100 for use with a prophy angle 10. The adaptor 100 includes a body 110 and a nose 112, and the nose 112 may be removably attachable to the body 110. Alternatively, the nose 112 may be integral with the body 110. The adapter 100 includes a shaft 118 that is connected to a collet 200 for receiving a rotating member 12 of the prophy angle 10.

The nose 112 includes a first bore 114 for receiving the rotating member 12 and, in certain configurations, a portion of the shaft 118 and/or collet 200. Additionally, the outer portion of the nose 112 may be shaped to mate with the prophy angle 10. As is known in the art, many types of different types of prophy angles 10 exist that have different mating profiles, and the present adaptor 100 is not limited as to a particular shape of the nose 112 and as to a particular profile of prophy angle 10 with which the nose 112 can mate. However, in a current aspect of the adapter 100, the nose 112 is a configured as a doriot-style adapter. Depending upon the type of prophy angle 10, other type of connections devices include, but are not limited to, latch type, 3-ball chuck, attachment ring, push chuck, quick-connect collars, autochucks, E-type (i.e., ISO 3964), DIN 13940, ISO 1797, U-type, NSK type, Midwest type.

The body 110 includes a second bore 116 for receiving the shaft 118 and, in certain configurations, also a portion of the rotating member 12. Additionally, the inner surface of the second bore 116 of the body 110 may be shaped to mate with a drive source, such as a micromotor. As is known in the art, many different configuration of drive sources exist that have different mating profiles, and the present adaptor 100 is not limited as to a particular profile of the second bore 116 with which the drive source can mate.

The shaft 118 is rotated by the drive source, which is connected to a coupler 126 positioned on one end 122 of the shaft 118, which drives a collet 200 connected on another end 120 of the shaft 118. In certain aspects of the adapter 100, both the coupler 126 and the collet 200 rotate about a common rotational axis RA. Moreover, both the collet 200 and the first bore 114 may share a common rotational axis. Many types of shafts 118 are capable of transmitting rotation from the coupler 126 to the collet 200, and the present adapter 100 is not limited as to a particular type of shaft 118 so capable.

As is known in the art, many different types of drive source exist and these different drive sources have different configurations for coupling with a rotating member, such as the shaft 118. In this regard, the present adapter 100 is not limited as to the type and configuration of coupler 126 that couples with the drive source. However, in certain aspects of the adapter 100, the coupler 126 is an E-type coupler. Other types of couplers/connection devices have been previously described with regard to the nose 112.

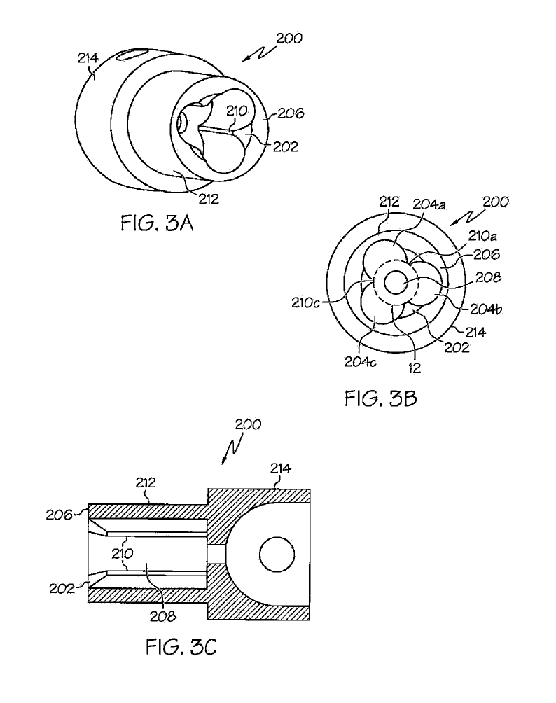

FIGS. 3A-3C further illustrate the collet 200. The collet 200 of the adaptor 100 is adapted to receive and hold the rotating member 12 of the prophy angle 10. In certain aspects of the adaptor 100, the collet 200 is not limited in the manner in which the collet 200 receives and holds the rotating member 12, and any configuration of the collet 200 so capable is acceptable for use with the adaptor 100.

In certain aspects of the adaptor 100, the collet 200 includes a plurality of extensions 210a-210c for receiving the rotating member 12. The innermost portions of the extensions 210a-210c define an inner collet bore 208 having a diameter slightly less than the diameter of the rotating member 12. In this manner, upon the rotating member 12 being positioned within the inner collet bore 208, an interference fit or friction grip exists between the plurality of extensions 210a-210c and the rotating member 12. The interference fit allows the extensions 210a-210c to hold onto the rotating member 12 and to transfer rotation from the collet 200 to the rotating member 12. In certain aspects of the collet 200, the innermost portions of the extensions 210a-210c define an inner collet bore 208 having a fixed diameter.

As best shown in FIG. 3A, the outer edge of each extension 210a-210c may also include a concave surface. The concave surfaces of the extensions 210a-210c can define the outer circumference of the inner collet bore 208 of the collet 200. These concave surfaces also mate with the outer surface of the rotating member 12 to form the interference fit between the plurality of extensions 210a-210c and the rotating member 12. Although not limited in this manner, the radius of the concave surfaces of the extensions 210a-210c is substantially equal to the radius of the collet bore 208. Although not limited in this manner, in certain aspects of the collet 200, the concave surfaces define less than 20% of the circumference of the collet bore 208.

The collet 200 may also include longitudinal chamfers 202 on the extensions 210a-210c. The chamfers may extend from a collet distal end 206 along each extension 210a-210c and slope inwardly towards the rotational axis of the collet 200. The longitudinal chamfers 202 provide a guide for receiving the rotating member 12. As the rotating member 12 is moved into the collet 200, the longitudinal chamfers 202 guide the rotating member 12 toward the inner collet bore 208. Although not limited in this manner, a face of the longitudinal chamfers 202 may be angled at about 60°±15° relative to the face of the distal end 206 of the collet 200.

The manner in which the inner collet bore 208 is formed is not limited. For example, the inner collet bore 208 may be formed by drilling the collet 200 along its centerline. By forming the inner collet bore 208 is this manner, the concave surfaces at the outer edge of each extension 210a-210c may also be formed. Also, the extensions 210a-210c may be formed by drilling offset bores 204a-204c, which have a centerline offset from the centerline of the collet 200. Although the term “drilling” is used herein, other methodology used to form bores/holes is also acceptable.

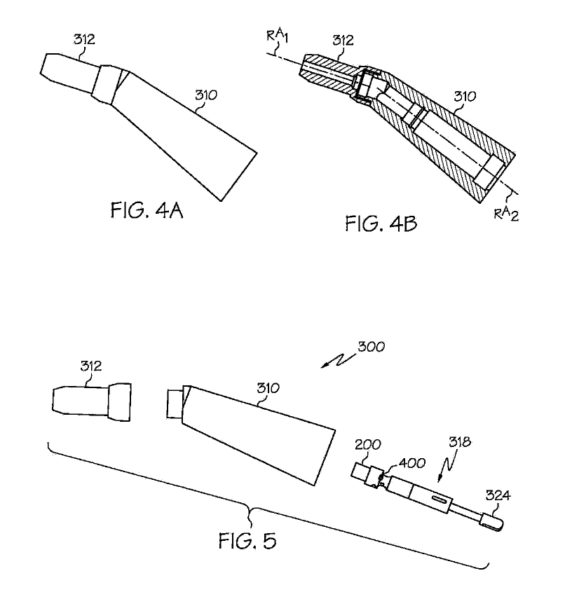

Referring to FIGS. 4A, 4B and 5, a contra-style (angled) adapter 300 is illustrated. An identifying feature of a contra-style adapter 300 is that the rotational axis RA₂ of the shaft 318 is at an angle to the rotational axis RA₁ of the collet 200. Similarly, the body 310 of the contra-style adapter 300 is at an angle to the nose 312 of the contra-style adapter 300. Although not limited in this manner, the contra-style adapter 300 is used in dentistry to obtain better access to the back teeth of a patient. In current aspects of the contra-style adapter 300, the angle between the rotational axis RA₂ of the shaft 318 and the rotational axis RA₁ of the collet 200 may be 19°±10°. However, other angles are possible.

Although illustrated as having a fixed angle between the rotational axis RA₂ of the shaft 318 and the rotational axis RA₁ of the collet 200, this angle may be variable. For example, the nose 312 may rotate relative to the body 310 about an axis perpendicular to either the rotational axis RA₂ of the shaft 318 or the rotational axis RA₁ of the collet 200. In this manner, the adapter 300 may be able to provide greater flexibility to a user using the adapter 300. Advantageously, this flexibility may be able to reduce the number of different types of adapters 300 a particular user may require. Any manner or configuration of allowing the nose 312 to rotate relative to the body 310 is acceptable for use with the present adapter 300. For example, the nose 312 may pivot relative to the body 310 about a pivot (not shown) connected to both the nose 312 and body 310.

As illustrated in FIG. 5, the nose 312 may be removably attachable to the body 310. Alternatively, the nose 312 may be integral with the body 310. Like the straight adapter 100 shown in FIGS. 1A, 1B and 2, the adapter 300 includes a shaft 318 that is connected to the collet 200. However, because the rotational axis RA₂ of the shaft 318 is at an angle to the rotational axis RA₁ of the collet 200 a multi-axis rotation joint 400 is positioned between the collet 200 and the shaft 318 to transfer the rotation of the shaft 318 to the collet 200. Similar to the straight adapter 100, the shaft 318 may also include a coupler 324 for driving the shaft 318.

Many types of joints are capable of transferring rotation from a first rotating member to a second rotating member, which is positioned off-axis from the first rotating member, and the present adapter is not limited as to a particular type of joint so capable. However, in a current aspect of the adapter 300, the multi-axis rotation joint 400 is a ball joint.

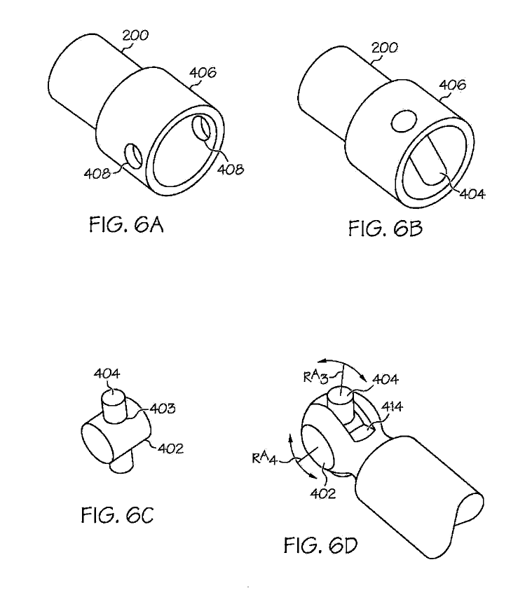

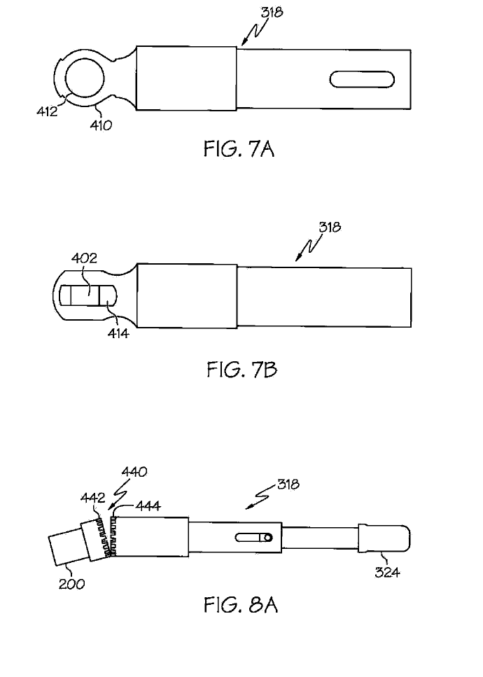

Referring to FIGS. 6A-6C and 7A, 7B, elements of a ball joint 400 are illustrated. Referring to FIG. 6A, the collet 200 is connected to a receiver 406 for receiving a head 410 of the ball joint 400. Although shown connected to the collet 200, the receiver 406 may be integral with the collet 200. Alternatively, another member (not shown) may be positioned between the receiver 406 and the collet 200. The use of a ball joint 400 advantageously reduces back lash, which is inherent in may types of joints.

Referring to FIGS. 6A and 6B, the receiver 406 includes openings 408 into which a second pin 404 is positioned. Although the second pin 404 may rotate within the openings 408 of the receiver 406, in a current aspect of the ball joint 400, the second pin 404 is positionally and rotationally fixed relative to the receiver 406. In so doing, the second pin 404 is prevented from moving within the receiver 406. Since the receiver 406, and thus the ends of the second pin 404, can rotate about the rotational axis RA₁ of the collet 200 at very high speeds, any movement of the ends of the second pin 404 beyond the outer circumference of the receiver 406 may cause engagement between the ends of the second pin 404 and inner surfaces of the nose 312 and/or the body 310 of the adapter 300. This engagement may cause failure of or damage to the adapter 300 and/or the ball joint 400.

The manner in which the second pin 404 is prevented from moving within the receiver 406 is not limited as to a particular technique or arrangement. For example, the second pin 404 can be attached to the receiver, for example, via welding or gluing. However, in a current aspect of the ball joint 400, the second pin 404 is sized slightly greater than the size of the openings 408 of the receiver 406 such that upon inserting the second pin 404 into openings 408, an interference fit exists between the second pin 404 and the openings 408.

Referring to FIGS. 6C and 6D, the second pin 404 is positioned within an opening 403 of a first pin 402, and the first pin 402 is positioned within a head 410. As also illustrated in FIGS. 7A and 7B, the head 410 includes slots 414 through which the second pin 404 extends. As presently configured, the first pin 402 rotates within and relative to the head bore 412 of the head 410 about a rotational axis RA₄, and the second pin 404 rotates within relative to the first pin 402 about a rotational axis RA₃. The outside diameter of the second pin 404 is somewhat less than the inside diameter of the inside diameter of the opening 403 of the first pin 402 to form a close tolerance slip fit between the second pin 404 and the first pin 402. Similar, the outside diameter of the first pin 402 is somewhat less than the inside diameter of the head bore 412 of the head 410 to form a close tolerance slip fit between the first pin 402 and the head bore 412 of the head 410.

Although not limited as to a particular range of rotation or to the particular manner described herein, the first pin 402, while within the head 402, is limited in its range of rotation by the length of the slot 414 in the head 410. As the length of the slot 414 increases, the range of the rotation of the first pin 402 within the head 410 is also increased. Conversely, upon the length of the slot 414 decreasing, the range of rotation of the first pin 402 within the head 410 is also decreased. The width of the slots 414 may be slightly less than the outside diameter of the second pin 404 to allow the second pin 404 to move from side-to-side within the slots 414.

With regard to the range of rotation of the second pin 404 within the first pin 402, the range of rotation is not necessarily limited when the first pin 402 is within the second pin 404 alone. However, upon the joint 400 being full assembled, the range or ration of the second pin 404 within the first pin 402 may be limited to some degree by interference between the collet 200 and the shaft 318.

Although illustrated as the head 410 being connected to the shaft 318 and the receiver 406 being connected to the collet 200, the ball joint 400 is not limited in this manner. For example, the head 410 may be connected to the collet 200, and the receiver 406 may be connected to the shaft 318.

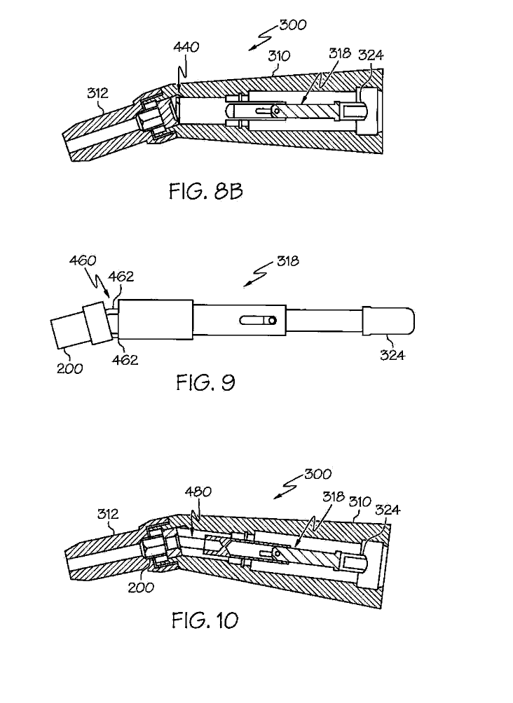

Unlike many other types of joints, a ball joint 400 allows for the angle between the rotational axis RA₂ of the shaft 318 and the rotational axis RA₁ of the collet 200 to be varied. For example, the bevel gears described within reference to FIGS. 8A, 8B and the links described with reference to FIG. 9 are designed for use with a fixed angle.

FIGS. 8A, 8B, 9, and 10 illustrate additional examples of joints 440, 460, 480 capable of transmitting rotation from the shaft 318 to the collet 200. In FIGS. 8A, 8B, the joint 440 may be formed through the use of bevel gears 442, 444 respectively formed on the collet 200 and shaft 318. The use of bevel gears 442, 444 allows the angular velocity transmitted by the shaft 318 to be either increased or decreased through the use of different gear ratios. Alternatively, the bevel gears 442, 444 may have a 1:1 gear ratio, in which the angular velocity of the collet 200 is equal to the angular velocity of the shaft

In FIG. 9, the joint 460 may comprise a plurality of links 462, which are connected to both the collet 200 and the shaft 318. The links 462 rotatably and slidably extend into a corresponding receiving holes within the collet 200 and the shaft 318. As the shaft 318 rotates, the links 462 move in and out of the receiving holes, which in turn causes the collet 200 to rotate. A similar type of joint 460 is described in U.S. Pat. No. 7,153,133 to Chia et al., which is incorporated herein, in its entirety, by reference.

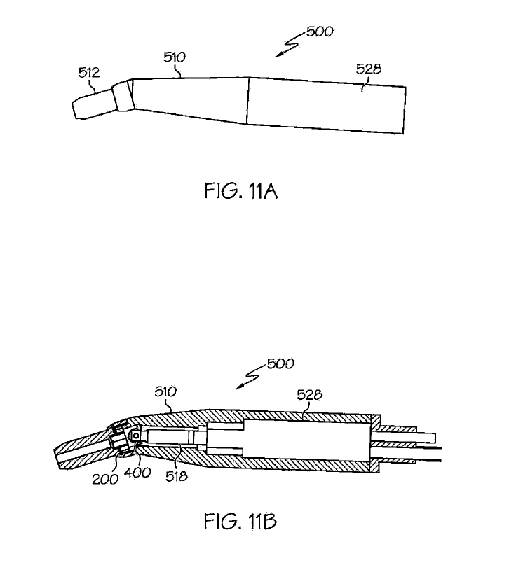

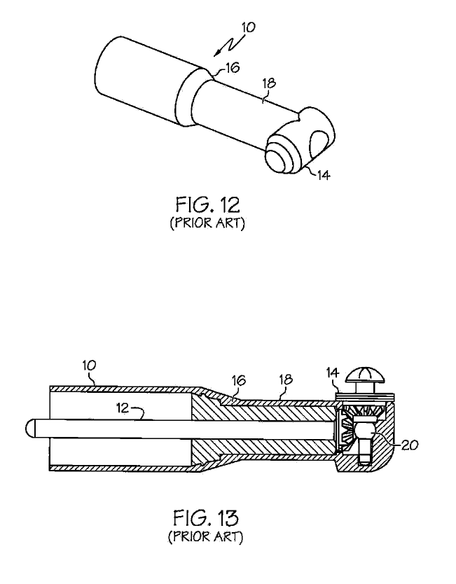

In FIG. 10, the joint 480 may be a flexible member that is directly connected to the collet 200 and the shaft 318. The flexible member 480 is not limited as to a particular type of material and/or configuration. However, in certain aspects, the flexible member 480 is formed from a material and configured to be both compressible and stretchable since as the shaft 318 and collet 200 rotate, the outer circumference of the flexible member 480 alternately compresses and stretches.

FIGS. 11A and 11B illustrate an adapter 500 with an micromotor 528 that is integral with the body 510 of the adapter 500. Although illustrated with a contra-style adapter 500, the micromotor 528 may be integrally formed with a straight adapter 100, such as illustrated in FIGS. 1A, 1B and 2. Upon using an integral micromotor 528 with the adapter 500, the shaft 518 may be directly connected to both the micromotor 528 and joint 400, and if the adaptor is a straight adapter, the shaft 518 may be directly connected to both the micromotor 528 and the collet 200.

Using micromotors to drive dental equipment is well known by those in the art, and any micromotor 528 so capable is acceptable for use with the present adapter 500. Examples of micromotors 528 include electrically-driven and pneumatically-driven motors. In the presently-illustrated adapter 500, the micromotor 528 is pneumatically driven.

1. An adapter for a prophy angle, comprising:
a collet configured to connect to a rotating member of the prophy angle;
a nose having a first bore and configured to receive the rotating member through the first bore;
a body having a second bore and connected to the nose; and
a shaft positioned within the second bore of the body, wherein
the shaft includes a first distal end and a second distal end,
the first distal end connects to the collet,
the second distal end includes a coupler, and
the collet includes a plurality of extensions for attaching to the rotating member, and
a fixed-diameter collet bore being defined by innermost portions of the extensions, and
the collet bore having a diameter smaller than a diameter of the rotating member.

2. The adapter according to claim 1, wherein the first bore and the second bore extend along a common axis.

3. The adapter according to claim 1, wherein the first bore and the second bore extend along separate axes.

4. The adapter according to claim 3, wherein the first distal end of the shaft connects to the collet with a rotation joint.

5. The adapter according to claim 4, wherein the rotation joint is a ball joint.

6. The adapter according to claim 1, wherein the outer portions of the extensions include concave surfaces.

7. The adapter according to claim 6, wherein a radius of the concave surfaces of the extensions is substantially equal to the radius of the collet bore.

8. The adapter according to claim 1, wherein the extensions include longitudinal chamfers sloping inwardly towards a rotational axis of the collet.

9. The adapter according to claim 1, wherein the nose is a doriot-style nose and the coupler is an E-type coupler.

10. The adapter according to claim 1, wherein,
the shaft has a rotational axis and the collet has a rotational axis, and
in operation of the adaptor, the nose being rotatable relative to the body about an axis perpendicular to either the rotational axis of the shaft or the rotational axis of the collet, whereby an angle between the rotational axis of the shaft and the rotational axis of the collet is variable.

11. An adapter for a prophy angle, comprising:
a collet configured to connect to a rotating member of the prophy angle;
a doriot-style nose having a first bore and configured to receive the rotating member through the first bore;
a body having a second bore and connected to the nose; and
a shaft positioned within the second bore of the body, wherein
the shaft includes a first distal end and a second distal end,
the first distal end connects to the collet, and
the second distal end includes an E-type coupler.

12. The adapter according to claim 11, wherein the first bore and the second bore extend along a common axis.

13. The adapter according to claim 11, wherein the first bore and the second bore extend along separate axes.

14. The adapter according to claim 13, wherein the first distal end of the shaft connects to the collet with a rotation joint.

15. The adapter according to claim 14, wherein the rotation joint is a ball joint.

16. The adapter according to claim 11, wherein,
the shaft has a rotational axis and the collet has a rotational axis, and
in operation of the adaptor, the nose being rotatable relative to the body about an axis perpendicular to either the rotational axis of the shaft or the rotational axis of the collet, whereby an angle between the rotational axis of the shaft and the rotational axis of the collet is variable.

17. A contra-angle adapter for a prophy angle, comprising:
a collet configured to connect to a rotating member of the prophy angle;
a nose having a first bore and configured to receive the rotating member through the first bore;
a body having a second bore and connected to the nose; and
a shaft positioned within the second bore of the body, wherein
the shaft includes a first distal end and a second distal end,
the first distal end connects to the collet with a ball joint, and
the second distal end includes a coupler.

18. The contra-angle adapter according to claim 17, wherein the ball joint includes a receiver connected to one of the collet and shaft and a head connected to an other of the collet and shaft.

19. The contra-angle adapter according to claim 17, wherein the nose is a doriot-style nose and the coupler is an E-type coupler.

20. A prophy angle driver, comprising:
a collet configured to connect to a rotating member of a prophy angle;
a nose having a first bore and configured to receive the rotating member through the first bore;
a micromotor attached to the nose; and
a shaft extending from the micromotor into the first bore and connected to the collet, wherein
the collet includes a plurality of extensions for attaching to the rotating member, and
a fixed-diameter collet bore being defined by innermost portions of the extensions, and
the collet bore having a diameter smaller than a diameter of the rotating member.

21. The driver according to claim 20, wherein the first bore and the shaft extend along a common axis.

22. The driver according to claim 20, wherein the first bore and the shaft extend along separate axes.

23. The driver according to claim 20, wherein the nose is a doriot-style nose and the coupler is an E-type coupler.

24. The driver according to claim 20, wherein,
the shaft has a rotational axis and the collet has a rotational axis, and
in operation of the adaptor, the nose being rotatable relative to the micromotor about an axis perpendicular to either the rotational axis of the shaft or the rotational axis of the collet, whereby an angle between the rotational axis of the shaft and the rotational axis of the collet is variable.

25. A contra-angle prophy angle driver, comprising:
a collet configured to connect to a rotating member of a prophy angle;
a nose having a first bore and configured to receive the rotating member through the first bore;
a micromotor attached to the nose; and
a shaft extending from the micromotor into the first bore and connected to the collet by a ball joint.

26. The driver according to claim 25, wherein the first bore and the shaft extend along separate axes.

27. The driver according to claim 25, wherein the nose is a doriot-style nose and the coupler is an E-type coupler.
